(19) United States
(12) Patent Application Publication
(10) Pub. No.: US 2007/0219002 A1
(43) Pub. Date: Sep. 20, 2007

(54) Flexible coupling for torque-transmitting connection of two elements, and assembly

(75) Inventors: Markus Duerre, Neuenburg (DE); Friedrich Back, Muellheim (DE)

Correspondence Address: HARNESS, DICKEY & PIERCE, P.L.C., P.O. BOX 828, BLOOMFIELD HILLS, MI, 48303, US

(73) Assignee: Carl Freudenberg KG, Weinheim (DE)

(21) Appl. No.: 11/724,641

(22) Filed: Mar. 15, 2007

(30) Foreign Application Priority Data
Mar. 17, 2006 (DE) 2006 012758.7

(51) Int. Cl. F16D 3/70

(52) U.S. Cl. 464/71

(57) ABSTRACT

A flexible coupling for torque-transmitting connection of two elements comprising a supporting body to which are assigned pick-up fixtures which are movably disposed relative to one another, to each pick-up fixture there is assigned at least one elastically deformable layer. Each pick-up fixture surrounds one at least partly spherically shaped elastic layer and a cylindrically shaped elastic layer, and wherein the layers cooperate during the relative movement of the pick-up fixtures. Such a flexible coupling finds use in an assembly.

### CROSS-REFERENCE TO RELATED APPLICATIONS

This application claims the benefit of DE 10 2006 012 758.7 filed Mar. 17, 2006. The disclosure of the above application is incorporated herein by reference.

### FIELD

The present teachings relate to a flexible coupling for torque-transmitting connection of two elements comprising a supporting body provided with pick-up fixtures that are movably disposed relative to one another and with at least one elastically deformable layer assigned to each pick-up fixture. The present teaching also relate to an assembly including the coupling.

### BACKGROUND

The statements in this section merely provide background information related to the present disclosure and may not constitute prior art.

For torque transmission between two shafts, elastic shaft couplings may often be used to dampen rotary vibrations and jolts that often occur. Elastic shaft couplings as a rule generally consist of connecting flanges of the shafts or shaft ends that are connected to each other, and of a flexible coupling disposed between the connecting flanges.

At defined angular distances on its outer periphery, the flexible coupling may be provided with pick-up fixtures that can accept means for connecting the flexible coupling with the connecting flanges.

Flexible couplings as a rule also generally consist of an elastomeric material which may be reinforced with a textile fabric. Motor vehicle construction also often use flexible couplings, known as Hardy flexible couplings, in which textile cords wrap around six or more pick-up fixtures so that a wrapping packet extends around each two adjacent pick-up fixtures. The textile cord and the pick-up fixtures are covered with an elastic material. The fabrication of such flexible couplings, however, is costly and time-consuming.

The flexible couplings on rear-engine vehicles or four-wheel-drive vehicles must compensate for axial or angular misalignment. At the same time, high torques of up to 2000 Nm must be transmitted.

These requirements can currently be met only by metallic constant-velocity joints or Hardy-flexible coup-lings.

### SUMMARY

The present teachings provide an assembly, which while inexpensive to produce, ensures reliable connection between two shaft ends.

A flexible coupling according to the present teachings is characterized in that each pick-up fixture comprises an at least partly spherical elastic layer and a cylindrical elastic layer, wherein the layers cooperate when the pick-up fixtures move relative to one another.

According to the present teachings, the cooperation of an at least partly spherical elastic layer and a cylindrical elastic layer create a series connection of the layers. The series connection brings about selective cooperation of the two elastic layers. When the shaft ends undergo axial movement, the cylindrical layer is more yielding than the at least partly spherical layer. During cardanic movements, the at least partly spherical layer is more yielding than the cylindrical layer. To this extent, the elastic layers act selectively when the shaft ends undergo certain movements relative to one another. In the event of axial movements, the cylindrical layer exerts its action and, in the event of cardanic movements, the at least partly spherical layer also exerts its action.

During cardanic shaft movements, the pick-up fixtures are also subjected to an axial movement which is superposed on their rotary movement. Moreover, both elastic layers exhibit an elevated torsional stiffness. By a combination of geometrically specially arranged layers, it is possible to produce a flexible coupling which may be flexibly adapted to the operating conditions of two rotating shafts. Moreover, such a flexible coupling can be produced at a low cost and is of simple design.

Each pick-up fixture may comprise a cylindrical sleeve and an at least partly spherical sleeve. The precaution of using a cylindrical sleeve permits problem-free pick up of a screw or pin to create a connection between elements, for example flanges, and the flexible coupling. This also applies to a partly spherical sleeve. Moreover, sleeves are rigid elements that may serve as bearings for fastening agents. The sleeves may be made of plastic material. Plastics are inexpensive materials characterized by high toughness and easy processing. Against this background, it is conceivable that the sleeves may be fabricated by injection molding.

The sleeves may also be made of metal. Metals are characterized by high heat resistance and high stability. To produce a particularly light-weight flexible coupling, a light metal such as aluminum may be used.

The cylindrical sleeve may be surrounded by the cylindrical elastic layer. In this case, the cylindrical elastic layer may be surrounded by the at least partly spherical sleeve, which in turn is surrounded by the at least partly spherical sleeve. In this design, the cylindrical sleeve may be arranged as an inner part. The cylindrical sleeve serves as an abutment for a fastening element which should not come in direct contact with the cylindrical elastic layer. In this manner, damage to the elastic layer may be prevented. The onionskin-like structure permits a firm connection of the individual elastic layers and sleeves with one another. Against this background, the elastic layer may be vulcanized or glued onto the outer periphery of the cylindrical sleeve. Moreover, the at least partly spherical sleeve may be vulcanized or glued onto the cylindrical elastic layer. The at least partly spherical elastic layer may be vulcanized or glued onto the outer jacket of the at least partly spherical sleeve. Vulcanization or gluing represents a durable and strong connection that makes it possible to insert a prefabricated pick-up fixture into a supporting body. Against this background, the sleeves and elastic layers may be connected to one another by press-fitting alone. Press-fitting or a press-fit allows an inexpensive and fast fabrication of the pick-up fixture.

The above also applies to a pick-up fixture in which at least the partly spherical sleeve may be configured as an inner part surrounded by a cylindrical sleeve. In this case, the cylindrical sleeve may be provided with a spherical inner partition and a cylindrical outer partition to accept the spherical sleeve. Entirely depending on the shape of the supporting body, the pick-up fixture may be arranged so that the cylindrical sleeve is configured either as an inner part or as an outer part. The design of the cylindrical sleeve as an outer part may have the advantage that only cylindrical holes may be provided in the supporting body in order for such a pick-up fixture to be accepted. This design, therefore, allows the supporting body to be of simple structure and of low-cost fabrication.

The at least partly spherically shaped elastic layers may have flattened regions. The flattened regions may be provided in the region of the equator, namely of the largest radial extension, of the pick-up fixture. The flattened regions permit the introduction of the pick-up fixture into a narrow space, because the at least partly spherical elastic layer may be compressed and the layer material may move into the zone of the flattened region. Moreover, the flattened regions make it possible to adjust the spring characteristics of the flexible coupling. The flattened regions form a gap with a partition into which the pick-up fixture is pressed. During torsional movement, this gap should be closed before the elastic layer touches the partition. To this extent, the flattened region may act almost as a free-wheeling system and constitutes an operation region with a soft characteristic curve.

The elastic layers may be made of rubber. Rubber is a reasonably priced material which may be connected with metallic structural parts by vulcanization in problem-free manner. It is also conceivable to make the elastic layers described here out of silicone or silicone rubber. This material is particularly reasonably priced and easily processed, because it may be introduced into hollow spaces by injection molding or applied onto elements. The elastic layers may also be made of MCU (microcellular urethane). This material stands out by its high chemical resistance. In particular, it has been found to be chemically resistant to most machine oils used.

The supporting body may, in at least some regions, be spherical in shape. This specific design allows the insertion of at least partly spherical pick-up fixtures into the supporting body. Against this background, the supporting body may be of a two-part design, with the two parts of the supporting body enclosing the pick-up fixtures. The two parts of the supporting body may be fabricated by deep drawing. The use of a deep-drawn part permits a fast fabrication process. The deep-drawn part may be made of sheet steel which stands out by its high stability. The two parts of the supporting body may be connected to each other by flanging, welding, or screwing together. Flanging permits fast connection of the two parts of the supporting body. Welding the two parts of the supporting body together ensures very high stability of the supporting body. Screwed-together supporting bodies may be readily opened to replace defective pick-up fixtures.

The supporting body may be made of aluminum by pressure die-casting. The choice of this material permits the fabrication of an unusually light-weight flexible coupling. The two parts of the supporting body may be joined by groove-and-tongue connections or, in general, by recesses and protrusions. The precaution of selecting mutually complementary means allows simple centering of the two parts of the supporting body when these parts are to be joined with one another.

The supporting body may be designed as a one-part element. This design is advantageous when the pick-up fixtures are spray-coated with a plastic material to achieve fast and reasonably priced fabrication.

Recesses may be provided in the supporting body on at least its outer periphery. When the pick-up fixtures are exposed to high cardanic loads, the fixtures may protrude at least partly from the supporting body without the at least partly spherical elastic layer being excessively deformed. Moreover, the fact that the pick-up fixtures may enter into the recesses ensures that during a rotary movement the pick-up fixture moves on a circular arc over as large an angular range as possible.

The supporting body may be shaped and flattened to form, between the elastic layer and the partition of the supporting body, a hollow space into which the pick-up fixture or the elastic layer may enter.

The flexible coupling may comprise a centering sleeve for receiving the shaft ends. The centering sleeve ensures that two shaft ends undergo nearly no displacement relative to one another.

The centering sleeve may be provided with an elastic layer. The elastic layer makes it possible for slight movements of the shaft ends to be compensated for and, in addition, contributes to the damping of vibrations.

An elastic layer may be disposed within the centering sleeve. This ensures that a journal or a shaft end may be accepted within the centering sleeve by press-fitting. The elastic layer may be made of an elastomer or rubber.

The elastic layer within the centering sleeve may be at least partly spherical in shape. The spherical shape makes it possible for the elastic layer, because of its curvature, to be subjected predominantly to shearing stresses. In this case, an arched elastic layer may achieve high radial stiffness nearly independently of its thickness, because in the event of a radial deflection, tensile-compressive loads are predominant. This minimizes wear on the layers.

An inner sleeve may adjoin the elastic layer. This measure permits highly accurate centering of a shaft end, because after its insertion the inner sleeve may be hollowed out in the elastic layer to compensate for unevennesses or acentric positioning. The inner sleeve may be fabricated of bronze to ensure high wear resistance. Fabrication of the inner sleeve out of a plastic material is especially reasonable in cost. The inner sleeve and/or the elastic layer may be spherical in shape.

Into the flexible coupling described herein may be inserted centering sleeves such as those described in DE 10 2005 055 800.3-27. The embodiments described in this German patent application, particularly those provided with an elastic layer, are expressly incorporated by reference in this application.

Moreover, the present teachings provide an assembly comprising a flexible coupling with a flange disposed on each side of the coupling, and one shaft end assigned to each flange, wherein each flange may be firmly connected with at least one pick-up fixture and each pick-up fixture may be connected exclusively with one flange.

The flexible couplings or assembly preferably contains four, six, or eight pick-up fixtures. The precaution of using four pick-up fixtures makes it possible to dispose two-arm flanges on each side of the flexible coupling. In this case, two different pick-up fixtures may be assigned to each two-arm flange. Three-arm or four-arm flanges may be utilized, with one pick-up fixture being assigned to each arm. All pick-up fixtures of the flexible coupling may be movable relative to one another to a minor extent.

The flexible couplings or assembly described herein are preferably used in motor vehicles, because motor vehicles with internal combustion engines generate torques and vibrations.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 shows a top view of an assembly with a flexible coupling and a three-arm flange;

FIG. 2 shows a section along line B-B of the assembly of FIG. 1; and

FIG. 3 shows a section along line C-C of FIG. 1.

### DETAILED DESCRIPTION

The following description is merely exemplary in nature and is not intended to limit the present disclosure, application, or uses.

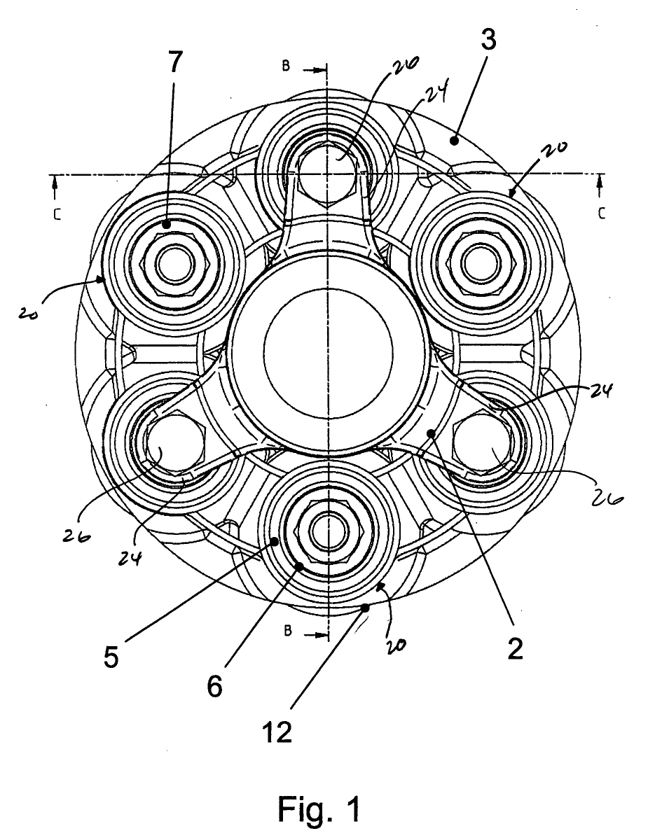

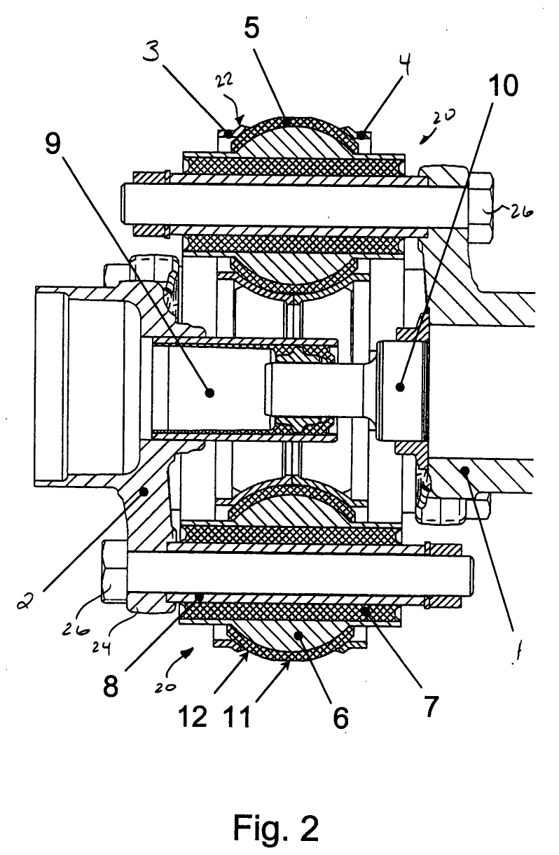

FIG. 1 shows a top view of an assembly with a three-arm flange 2 that is connected with three pick-up fixtures 20 of a flexible coupling. As showin in FIG. 2, the pick-up fixtures 20 are comprised of a cylindrical sleeve 8, a cylindrically shaped layer 7, and an at least partly spherically shaped sleeve 6. Assigned to the layer 7 may be an at least partly spherically shaped layer 5.

Moreover, FIG. 1 shows an upper portion 3 of the two-part supporting body 22. As shown in FIG. 2, two-part supporting body 22 includes upper portion 3 and a lower portion 4. Between upper portion 3 and lower portion 4, there is provided, at least on the outer periphery thereof, recesses 12 through which pick-up fixtures 20 extend.

In FIG. 1 illustrates an assembly in which a flexible coupling is provided with pick-up fixtures 20. One shaft end 10 is assigned to each flange 1 and 2. Flanges 1 and 2 are in the form of three-arm flanges with one pick-up fixture 20 assigned to each arm 24. Each arm 24 of each flange 1 and 2 is connected firmly to one pick-up fixture 20 by means of screws 26. Each pick-up fixture 20 may be connected exclusively with one flange 1 and 2, or one arm 24 of flanges 1 and 2.

FIG. 2 shows a sectional view along line B-B of FIG. 1. FIG. 2 shows an assembly with the flexible coupling for connecting, in torque-transmitting manner, three-arm flanges 1 and 2.

The flexible coupling comprises a supporting body 22 including upper portion 3 and lower portion 4 to which are assigned pick-up fixtures 20. Pick-up fixtures 20 may be disposed movably relative to one another. To each pick-up fixture 20 may be assigned elastically deformable layers 5 and 7. That is, each pick-up fixture 20 has an at least partly spherically shaped layer 5 and a cylindrically shaped elastic layer 7. During the relative movement of the pick-up fixtures 20, layers 5 and 7 cooperate and act almost as a series connection. This series connection functions in a manner analogous to that of two helical springs of which one has a very high spring rate and the other a very low spring rate.

Each pick-up fixture 20 comprises a cylindrical sleeve 8 and one at least partly spherical sleeve 6.

Cylindrical sleeve 8 is surrounded by cylindrical elastic layer 7. Cylindrical elastic layer 7 is surrounded by the at least partly spherical sleeve 6, and partly spherical sleeve 6 is surrounded by the at least partly spherical elastic layer 5. In some regions, the at least partly spherical layer 5 contacts supporting body 22. Spherically shaped layers 5 may be provided with flattened regions 11.

In at least some regions, supporting body 22 may be shaped spherically, and as stated above may consist of an upper portion 3 and a lower portion 4. In supporting body 22, recesses 12 are formed at least on the outer periphery of the supporting body 22. The at least partly spherically shaped elastic layer 5, together with the at least partly spherically shaped sleeve 6, may extend into recesses 12.

The flexible coupling is provided with a centering sleeve 9 for accepting shaft ends 10.

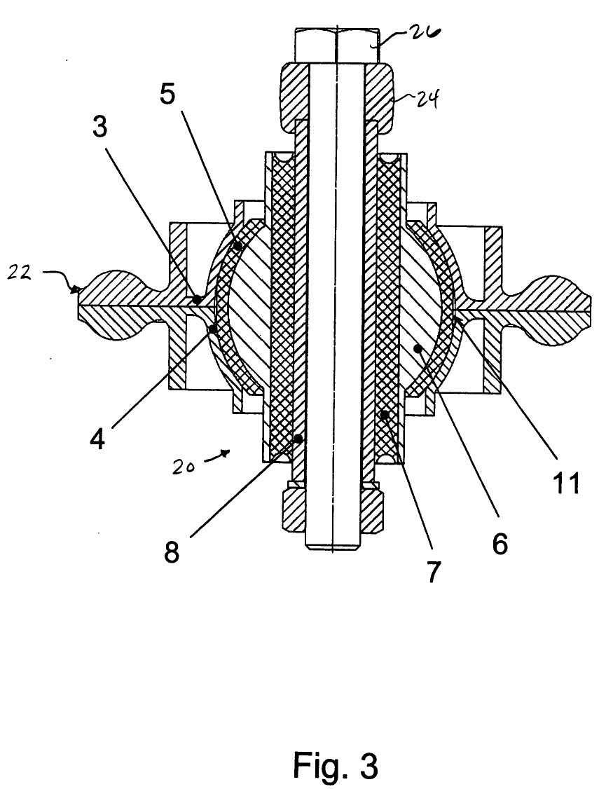

FIG. 3 is a sectional view along line C-C of FIG. 1. FIG. 3 shows a pick-up fixture 20 of FIG. 1. The fixture 20 is embedded into a two-part supporting body 22. The at least partly spherically shaped elastic layer 5 may be provided with a flattened region 11, which together with the partition of supporting body 22, forms a gap into which elastic layer 5 can enter.

Moreover, FIG. 3 shows that the pick-up fixture 20 comprises a cylindrical sleeve 8, a cylindrical elastic layer 7, and an at least partly spherically shaped sleeve 6.

What is claimed is:

1. A flexible coupling for torque-transmitting connection of two elements, comprising:
a supporting body; and
a plurality of pick-up fixtures disposed within said supporting body that are disposed movably relative to one another, each pick-up fixture including at least one elastically deformable layer,
wherein each pick-up fixture surrounds one at least partly spherically shaped elastic layer and a cylindrically shaped layer, the partly spherically shaped elastic layer and the cylindrically shaped layer cooperating during relative movement of the pick-up fixtures.

2. The flexible coupling as defined in claim 1, wherein each pick-up fixture surrounds one cylindrical sleeve and one at least partly spherically shaped sleeve.

3. The flexible coupling as defined in claim 2, wherein the cylindrical sleeve is surrounded by the cylindrical elastic layer, the cylindrical elastic layer being surrounded by the at least partly spherically shaped sleeve and the sleeve being surrounded by the at least partly spherically shaped layer.

4. The flexible coupling as defined in claim 2, wherein the at least partly spherically shaped sleeve is surrounded by the at least partly spherically shaped layer, the at least partly spherically shaped layer being surrounded by the cylindrical sleeve and the sleeve being surrounded by the cylindrical elastic layer.

5. The flexible coupling as defined in claim 1, wherein the at least partly spherically shaped elastic layers are provided with flattened regions.

6. The flexible coupling as defined in claim 1, wherein the supporting body is spherically shaped in at least some regions.

7. The flexible coupling as defined in claim 1, wherein recesses are provided in at least an outer periphery of the supporting body.

8. The flexible coupling as defined in claim 1, further comprising a centering sleeve disposed in the supporting body for accepting an end of a shaft.

9. The flexible coupling as defined in claim 8, wherein the centering sleeve is provided with an elastic layer.

10. An assembly comprising a flexible coupling according to claim 1, wherein the flexible coupling includes a first side and a second side, the first and second sides having at least one flange, each flange is assigned an end of a shaft, and each flange being connected with at least one pick-up fixture.

11. A flexible coupling comprising:
a support body supporting a first flange and a second flange; and
a plurality of pick-up fixtures disposed between said first flange and said second flange, each pick-up fixture including a cylindrical sleeve, a cylindrically shaped elastic layer, an at least partly spherically shaped sleeve, and an at least partly spherically shaped elastic layer,
wherein said cylindrically shaped elastic layer yields to a greater extent than said partly spherically shaped elastic layer during movement of said pick-up fixtures.

12. The flexible coupling of claim 11, wherein said pick-up fixtures move cardanically and axially.

13. The flexible coupling of claim 11, wherein said first flange and said second flanges each include a plurality of arms, said pick-up fixtures disposed between said arms of said first flange and said second flange.

14. The flexible coupling of claim 11, wherein said at least partly spherically shaped elastic layer includes flat regions.

15. The flexible coupling of claim 11, wherein said supporting body includes at least one recess.
